(19) United States
(12) Patent Application Publication
(10) Pub. No.: US 2024/0220281 A1
(43) Pub. Date: Jul. 4, 2024

(54) MAPPING HARDWARE COMPONENTS TO A SERIES OF CALCULATIONS

(71) Applicant: Meta Platforms Technologies, LLC, Menlo Park, CA (US)

(72) Inventors: Vignesh Vivekraja, Santa Clara, CA (US); Tomonari Tohara, Sunnyvale, CA (US); Reza Tusi, San Jose, CA (US); Abuduwaili Tuoheti, San Jose, CA (US); Weiping Liu, Fremont, CA (US); Javid Jaffari, San Diego, CA (US)

(21) Appl. No.: 18/525,443

(22) Filed: Nov. 30, 2023

Related U.S. Application Data
(60) Provisional application No. 63/477,534, filed on Dec. 28, 2022.

(51) Int. Cl. G06F 9/445; G06N 3/0464

(52) U.S. Cl. CPC G06F 9/44505; G06N 3/0464

(57) ABSTRACT

In one embodiment, a method includes accessing a computational graph representing computations to be executed on a computing system comprising a plurality of Execution Units (EUs), identifying a set of candidate mapped-graphs for the computational graph, where each node in a candidate mapped-graph is mapped to an EU capable of calculating the node, ensuring that each edge from a first node to a second node in each candidate mapped-graph satisfies memory constraints, determining an expected cost for executing each candidate mapped-graph using mapped-EUs in the candidate mapped-graph for calculating respective nodes, and selecting a candidate mapped-graph with a least expected cost from the set of candidate mapped-graphs.

### PRIORITY

This application claims the benefit under 35 U.S.C. § 119(e) of U.S. Provisional Patent Application No. 63/477534, filed 28 Dec. 2022, which is incorporated herein by reference.

### TECHNICAL FIELD

This disclosure generally relates to utilizing hardware components of a system and, more particularly, to mapping hardware components to a series of calculations.

### BACKGROUND

Neural networks are increasingly being used to implement machine learning (ML) techniques to solve a wide variety of problems including, but not limited to, object identification, feature classification, or content-driven image processing. Some neural networks, which may be referred to as convolutional neural networks, include one or more convolutional layers. In a convolutional neural network (CNN), the convolutional layers typically account for the vast majority of the computations performed and the data movement within the CNN and/or between the CNN and other elements of an ML model, making them a performance bottleneck. Existing ML accelerators focus on using high compute parallelism along with an optimized data orchestration throughout the memory hierarchy to speed up the processing of convolutional layers. However, existing ML accelerators may not perform well when implemented within edge devices that have strict power consumption constraints and that run inference exercises using previously trained models in real time. For example, existing ML accelerators may not perform well within artificial reality systems for virtual reality (VR), augmented reality (AR), mixed reality (MR), or hybrid reality implemented on standalone head-mounted displays (e.g., on AR/VR headsets), mobile devices or other edge computing devices.

### SUMMARY OF PARTICULAR EMBODIMENTS

In particular embodiments, when machine-learning computations represented by a computational graph are to be performed on a computing system comprising a plurality of execution units (EUs), a system may map each calculation represented by each node of the computational graph to a respective EU among the plurality of EUs to optimize cost associated with the ML computations. A computational graph may be used for representing machine-learning (ML) computations. A computational graph may comprise a plurality of nodes and one or more directional edges. A node may represent a calculation to be performed on input data of the node. A directional edge from a first node to a second node may indicate that output of a first calculation represented by the first node is fed to a second calculation represented by the second node as input. In particular embodiments, ML computations represented by a computational graph may be executed on a computing system comprising a plurality of Execution Units (EUs). In particular embodiments, an EU may comprise one or more computing elements and one or more memory elements. A part of the one or more memory elements may store input data fed to the one or more computing elements. A part of the one or more memory elements may store output data generated by the one or more computing elements. In particular embodiments, the EU may be a tensor execution unit, a vector execution unit, an accelerator, a scalar execution unit, or any suitable execution unit. In particular embodiments, an EU may be a dedicated EU or a configurable EU. A dedicated EU may have a microarchitecture tuned for processing an input data of particular type and shape. A configurable EU may be designed to support multiple data shapes, which can be configured at runtime. In particular embodiments, the computing system may comprise a processor that comprises the plurality of EUs. In particular embodiments, the computing system may comprise the plurality of EUs distributed from a processor. In particular embodiments, a compiler may map the calculation represented by each node of the computational graph to a respective EU among the plurality of EUs of the computing system to optimize a cost associated with the ML computations before the ML computations represented by the computational graph is executed on the computing system. In particular embodiments, the computing system may optimize the cost by mapping the nodes with respective EUs at runtime.

In particular embodiments, a system may access the computational graph representing computations to be executed on the computing system comprising a plurality of EUs. In particular embodiments, the system may identify a set of candidate mapped-graphs for the computational graph. In a candidate mapped-graph, each node may be mapped to an EU capable of calculating the node. To identify the set of candidate graphs, the system may identify, for each node in the computational graph, one or more EUs among the plurality of EUs that are capable of performing the calculation represented by the node. For a configurable EU, the system may identify every configuration of the configurable EU that is capable of performing the calculation represented by the node. Then, the system may identify the set of candidate mapped-graphs based on the identified one or more EUs for each node in the computational graph. Each candidate graph in the set may have a unique combination of node and EU mappings. In particular embodiments, a brute force algorithm may be used for identifying the set of candidate mapped-graphs for the computational graph. The brute force algorithm may identify all possible combinations of mappings between the nodes and their capable EUs. In particular embodiments, a heuristic algorithm that decreases a number of the candidate mapped-graphs in the set may be used for identifying the set of candidate mapped-graphs for the computational graph. The system may ensure that each edge from a first node to a second node in each candidate mapped-graph satisfies memory constraints. To ensure, the system may, for each edge in each candidate mapped-graph, insert a third node for converting a first shape of an output from the first node to a second shape of input to the second node between the first node and the second node in the candidate mapped-graph when the system determines that the first shape mismatches the second shape. Inserting the third node to the candidate mapped-graph may also comprise mapping the third node to an EU capable of converting the first shape to the second shape. Converting the first shape to the second shape may comprise a memory transpose, adding paddings, or any suitable operation for a data shape conversion.

The system may determine an expected cost for executing each candidate mapped-graph using mapped-EUs for calculating respective nodes. The expected cost may be measured by latency, energy consumption, compute utilization, or any suitable measurement. The system may select a candidate mapped-graph with a least expected cost from the set of candidate mapped-graphs.

The embodiments disclosed herein are only examples, and the scope of this disclosure is not limited to them. Particular embodiments may include all, some, or none of the components, elements, functions, operations, or steps of the embodiments disclosed above. Embodiments according to the invention are in particular disclosed in the attached claims directed to a method, a storage medium, a system and a computer program product, wherein any element mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the elements thereof are disclosed and can be claimed regardless of the dependencies chosen in the attached claims. The subject-matter which can be claimed comprises not only the combinations of elements as set out in the attached claims but also any other combination of elements in the claims, wherein each element mentioned in the claims can be combined with any other element or combination of other elements in the claims. Furthermore, any of the embodiments and elements thereof described or depicted herein can be claimed in a separate claim and/or in any combination with any embodiment or element described or depicted herein or with any of the elements of the attached claims.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### BRIEF DESCRIPTION OF THE DRAWINGS

FIG. 1A illustrates selected elements of an example convolutional layer in a convolutional neural network (CNN).

FIG. 1B illustrates example calculations to perform convolutions.

FIG. 1C illustrates an example pseudo code for convolutions between an activation tensor and filters.

FIG. 2 illustrates an example architecture for mapping each calculation represented by each node of a computational graph to a respective EU among a plurality of EUs of a computing system to optimize cost associated with the computations.

FIG. 3 illustrates an example comparison of two ML acceleration approaches.

FIG. 4 illustrates a comparison between dedicated EUs and configurable EUs.

FIG. 5 illustrates example architectures of Tensor EU A and Tensor EU B with 64 Multiply-Accumulate (MAC) units.

FIG. 6 illustrates an example method 600 for mapping each calculation represented by each node of a computational graph to a respective EU among a plurality of EUs of a computing system to optimize cost associated with the computations.

FIG. 7 illustrates an example procedure for ensuring that each edge from a first node to a second node in a candidate mapped-graph satisfies memory constraints.

FIG. 8 illustrates an example computer system.

### DESCRIPTION OF EXAMPLE EMBODIMENTS

Before discussing the present embodiments in detail, it may be beneficial to first provide some background information regarding neural networks (NNs) and machine learning (ML) models in general. Machine-learning techniques have been used in a number of domains such as computer vision, natural language processing, video context understanding, self-driving cars, etc. Neural Networks (NN)/Deep Learning (DL) algorithms are the most popular and are the focus of this disclosure. These algorithms learn from massive datasets during a compute intensive process called training, by repeatedly adjusting parameters of the NN (Weights and Bias) to minimize the error between a NN output and a pre-recorded ground-truth. Once training is complete, these network parameters are fixed and deployed in the real world called inference. The focus of this disclosure is on inference use-cases, but many of the disclosures may be applied to training as well.

Convolution Neural Networks (CNNs) are a class of NNs used popularly in computer vision and image processing. A CNN may constitute a stack of convolutional layers followed by a non-linear function like a rectified linear unit (ReLU), a leaky-ReLU, Sigmoid, etc., which may be grouped together as a singular block. A CNN may also consist of other operators such as pooling, fully-connected (FC) layers to change the dimensionality of intermediate data and a SoftMax layer to normalize the outputs to a probability distribution. These components are stacked in different combinations to represent unique NN architectures. Networks have high learning-capacity/representative-power roughly proportional to the compute complexity, which may be measured by a number of multiply-accumulate operations and the number of parameters. Typically, convolutional layers, FC layers are the most compute intensive and benefit significantly with hardware acceleration.

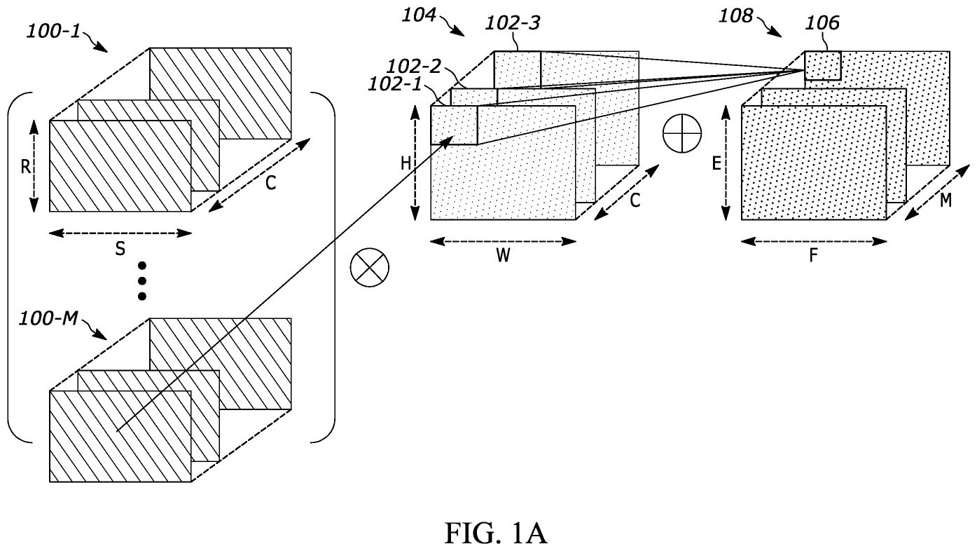

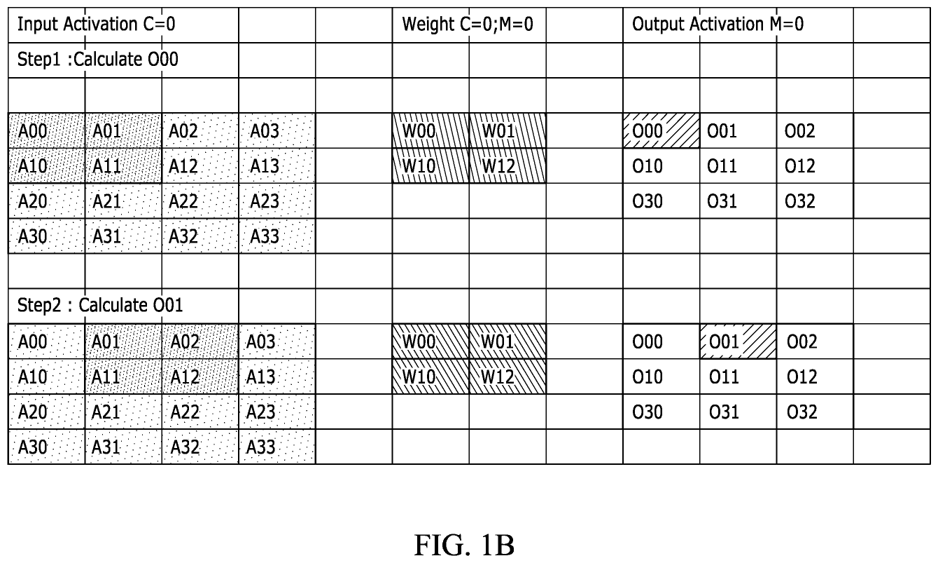

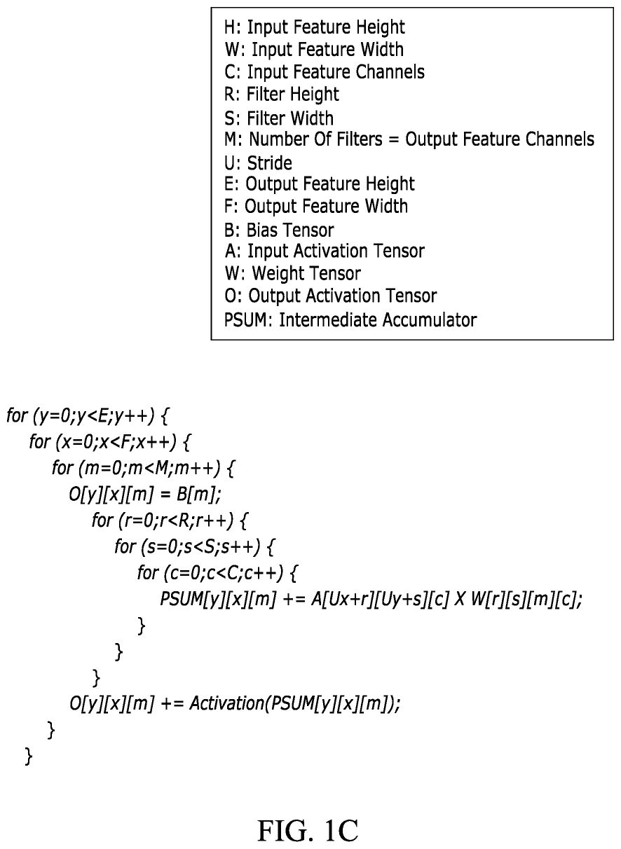

FIG. 1A illustrates selected elements of an example convolutional layer in a convolutional neural network. In the illustrated example, a three-dimensional (3D) output activation tensor 108 is generated by performing a series of two-dimensional (2D) convolution operations over a 3D input activation tensor 104 using a collection of 2D convolution kernels 100. More specifically, the input activation tensor 104 has dimensions H (height)×W (width)×C (where C represents a number of input channels) and the output activation tensor 108 has dimensions E×F×M (where M represents a number of output channels). In this example, multiple kernels 100 are to be applied to the input activation tensor to generate each element, of each channel, of the output activation tensor. More specifically, a respective different kernel 100 is applied to produce the elements of the output activation tensor for each given output channel. Therefore, the number of kernels 100 (i.e., M) matches the number of output channels (M).

As shown in FIG. 1A, each 3D filter 100 includes a respective 2D kernel of dimensions R×S for each input channel C, and each 2D filter kernel defines a collection of weights, where a respective weight value is associated with each filter element, as identified by its position within the R×S kernel. For example, each 2D filter kernel may be represented as a 3×3 grid of weights to be convolved with a similarly-sized collection of pixel elements within input activation tensor 104. More specifically, each 2D kernel of filter 100-M is applied in a convolution operation over the elements in a respective channel of input activation tensor 104. For example, a first 2D kernel of filter 100-M provides the weights that are multiplied by respective values of the elements in an R×S sized portion 102-1 of the elements of a first channel of input activation tensor 104, a second 2D kernel of filter 100-M provides the weights that are multiplied by respective values of the elements in an R×S sized portion 102-2 of the elements of a second channel of input activation tensor 104, and so on, such that a final 2D kernel of filter 300-M provides the weights that are multiplied by respective values of the elements in an R×S sized portion 102-3 of the elements of the last channel of input activation tensor 104. The results of these multiplication operations are then combined to generate a single element 106 of a single channel of output activation tensor 108, as shown in FIG. 1A. This process is repeated as the 2D kernels of filter 100-M are applied to other portions of input activation tensor 104 to produce the remaining elements of output activation tensor 108 in the same output channel as element 106, and as the 2D kernels of respective other ones of the filters 100 are applied to input activation tensor 104 to produce the elements of output activation tensor 108 in each of the remaining output channels.

FIG. 1B illustrates example calculations to perform convolutions. In the example illustrated in FIG. 1B, the input activation tensor is of size 4×4, with C input channels. Filters are of size 2×2, stride=1 with C input and M output channels. For brevity, FIG. 1B shows the operator being performed on each input channel and 1 output channel. In step 1, the 4 weights (W00, W01, W10, W12) are overlapped with 4 corresponding input activations (A00, A01, A10, A11) to calculate the first outputs 000 using the following dot product equation O00=A00*W00+A10*W10+A01*W01+A11*W12. In step 2, Now the weights are shifted by 1 entry to the right to produce O01 by O01=A01*W00+A02*W01+A11*W10+A12*W12. The steps are repeated across the entire input along the spatial axis to produce the output activation tensor for each input channel and output channel. The operation is repeated and accumulated across all C input channels to produce the output for 1 output channel. Further, convolution is repeated across M filters to produce the 3D output tensor.

FIG. 1C illustrates an example pseudo code for convolutions between an input activation tensor and filters. A shape of the input activation tensor is H×W×C, where H is an input activation height, W is an input activation width, and C is a number of input channels. A shape of an output activation tensor is E×F×M, wherein E is an output activation height, F is an output activation width, and M is a number of 3D filters. In the pseudo code illustrated in FIG. 1C, the filters are stored in 4D tensor, whose shape is R×S×M×C. A shape of an intermediate accumulator is identical to the shape of the output activation tensor, which is E×F×M. Biases are stored in an array size of M.

### Problem Statements

In particular embodiments, when computations represented by a computational graph are to be performed on a computing system comprising a plurality of execution units (EUs), a system may map each calculation represented by each node of the computational graph to a respective EU among the plurality of EUs to optimize cost associated with the computations. Many workloads in the computer vision and imaging domain may involve processing and manipulating variable sized multi-dimensional tensors. The involved data processing may be either memory transforms, arithmetic, or logical operations. Typically, processors may process these in Single Instruction Multiple Data (SIMD) engines for increased throughput. Single Instruction Multiple Data (SIMD) is used for cases where a single instruction operates on multiple data simultaneously. A typical example of a SIMD instruction may be:
add reg1, reg2, reg3
   In this example, reg1, reg2 and reg3 are vectors that contain 8-bit integer type values and each contain 8 elements. The add instruction operates on all 8 elements of reg2 and reg3 and stores the 8 output values into reg1. Even with SIMD engines, the compute and energy efficiency of these workloads may be suboptimal when the tensor shapes do not line up well with underlying hardware microarchitecture. Systems and methods to decrease compute latency and boost energy efficiency for a variety of operator shapes are proposed herein. While examples illustrated in the disclosure are tensor multiplications or convolutions, the proposed solutions may be applicable to other data formats.

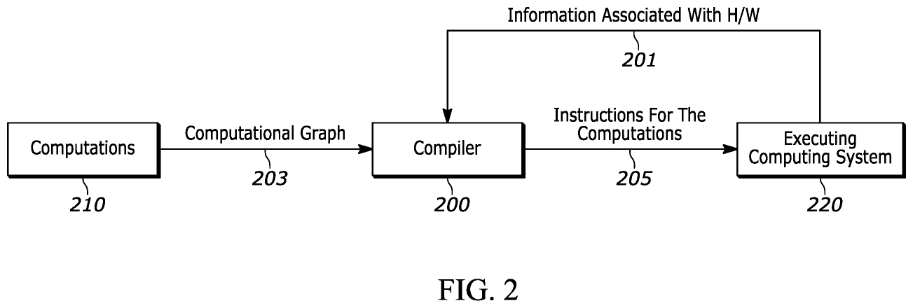

FIG. 2 illustrates an example architecture for mapping each calculation represented by each node of a computational graph to a respective EU among a plurality of EUs of a computing system to optimize cost associated with the computations. A compiler 200 may access information associated with hardware components 201, including the plurality of EUs, of a computing system 220 that executes computations. The compiler 200 may also access a computational graph 203 representing a series of computations 210. In particular embodiments, the series of computations 210 may be ML computations. The compiler 200 may execute an algorithm for mapping each calculation represented by each node within the computational graph 203. Based on the mapping, the compiler 200 may provide instructions 205 for executing the series of computations 210. The instructions 205 may specify which EU performs each calculation represented by each node in the computational graph 203.

### Hardware Architecture

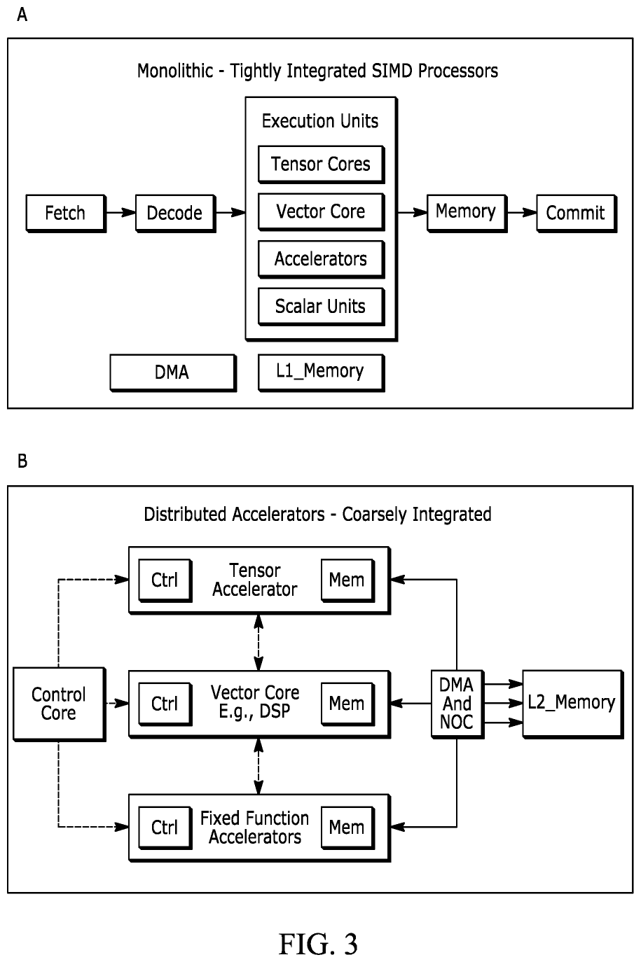

In particular embodiments, a computing system 220 used for executing a series of computations 210 may comprise a plurality of EUs. In particular embodiments, the series of computations 210 may be machine-learning (ML) computation. In particular embodiments, the computing system 220 may comprise a processor that comprises the plurality of EUs. In particular embodiments, the computing system may comprise the plurality of EUs distributed from a processor. Mapping ML computations with high compute complexity into scalar processors may be slow and inefficient. Some types of operations in CNN may be optimized by mapping to dedicated hardware execution units. For example, matrix-multiply and convolution function can be accelerated by mapping to a 2D multiply-accumulate hardware. Such implementations may benefit from additional computational resources, data-flow and hardware microarchitecture which promotes higher memory reuse, compute utilization and better area efficiency. FIG. 3 illustrates an example comparison of two ML acceleration approaches. In a first approach shown in FIG. 3 (A), processing units (aka execution units) are tightly integrated into the processor pipeline, typically at cycle level granularity. For example, the execution units in FIG. 3 (A) may be integrated into the execution stage of the 5-stage simple Reduced Instruction Set Computer (RISC) processor pipeline. Typically adding a new execution unit is area efficient as the new processing unit amortizes the cost of common shared resources such as core pipeline, memories etc. However, the new execution unit may add complexity as each new execution unit affects the microarchitecture of the processor itself. Also, such architecture promotes tight dataflow across execution units which are tightly coupled using memories either at register file or L1 memory level.

The second approach shown in FIG. 3 (B) is to build distributed execution units with its own set of control and memories and connect them using larger latency 2nd level memories and Network on chip (NOC). A common control core might be employed to synchronize across the execution units and support functionality not serviced by the dedicated execution units. Due to coarse grain integration amongst execution units, such processors might experience overheads in communicating and synchronizing data across the execution units. However, such processors may gain by allowing lesser micro-architecture dependencies in optimizing of each unit.

In particular embodiments, an EU may comprise one or more computing elements and one or more memory elements. A part of the one or more memory elements may store input data fed to the one or more computing elements. A part of the one or more memory elements may store output data generated by the one or more computing elements. In particular embodiments, the EU may be a tensor execution unit, a vector execution unit, an accelerator, a scalar execution unit, or any suitable execution unit.

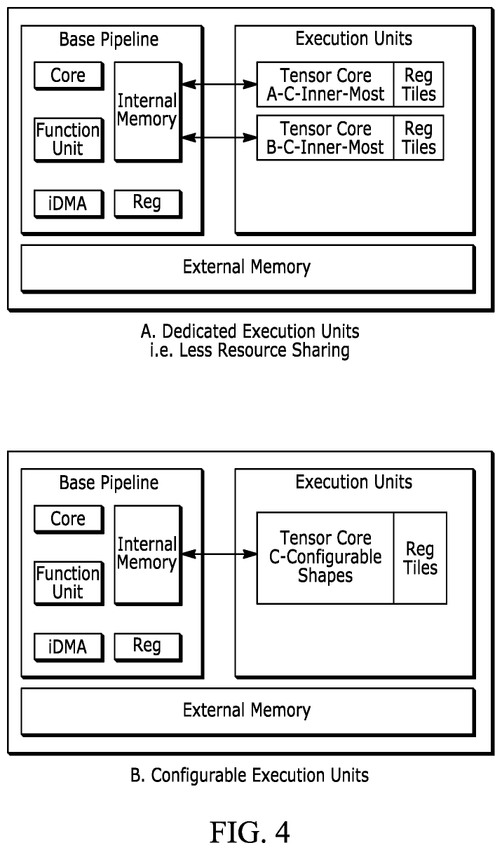

In particular embodiments, an EU may be a dedicated EU or a configurable EU. FIG. 4 illustrates a comparison between dedicated EUs and configurable EUs. While the EUs illustrated in FIG. 4 are tensor execution units that perform matrix multiplications on large tensors in a tiled manner This disclosure may contemplate any other suitable type of execution units. The EUs illustrated in FIG. 4 may be tightly integrated with the base processor pipeline. The architecture of an execution unit along with the shape, size and datatype of input and output data may influence the efficiency. For example, tensor sizes of the input and output for a matrix multiplication using a tensor execution unit may influence the efficiency.

In particular embodiments, a dedicated EU may have a microarchitecture tuned for processing an input data of particular type and shape. A computing system 220 may comprise a plurality of dedicated EUs, each with a different microarchitecture tuned for particular shapes, sizes, and datatypes of input and output data. These execution units might or might-not share underlying hardware and can potentially be operated parallelly or in a mutually exclusive manner, depending on an architecture choice. For example, two different tensor EUs, Tensor EU A and Tensor EU B, for matrix multiplication processing on integer data type are presented in FIG. 4 (A).

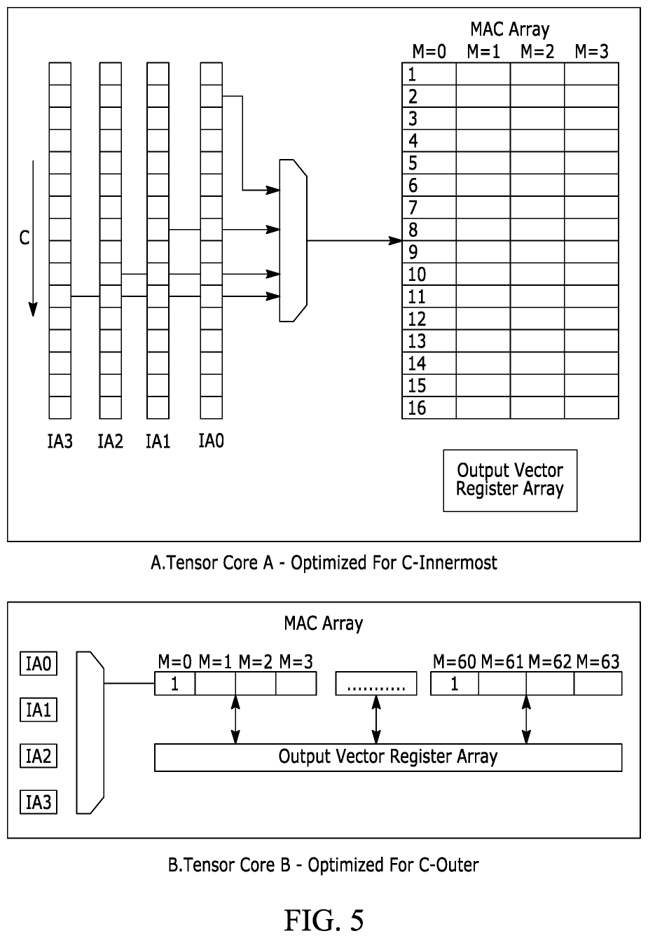

FIG. 5 illustrates example architectures of Tensor EU A and Tensor EU B with 64 Multiply-Accumulate (MAC) units. Tensor EU A may be optimized for C being inner most. The EU A may have a set of dedicated register files for holding input activations, weights, and output. The example illustrated in FIG. 5 (A) supports 16 C and 4 M. When a matrix multiplication has C less than 16, the Tensor EU A illustrated in FIG. 5 (A) may experience a loss in compute efficiency. Tensor EU B illustrated in FIG. 5 (B) may be efficient for tensor shapes C being outermost. Instead of performing a vector-by-vector dot product as in Tensor EU A, Tensor EU B may perform a vector-by-scalar to produce a vector output. Input activation may be a scalar instead of a vector which is broadcast to 64 weights to produce 64 outputs which are accumulated in the output vector register. Tensor EU B may have good compute utilization even when C=1, whereas Tensor EU A could operate only at 1/16th compute utilization. However, Tensor EU B may consume more energy. Thus, Tensor EU B illustrated in FIG. 5 (B) should be used only for shapes which are suboptimal when mapped to Tensor EU A illustrated in FIG. 5 (A).

In particular embodiments, a configurable EU may be designed to support multiple data shapes, which can be configured at runtime. A single monolithic execution unit as illustrated in FIG. 4 (B) may be designed to support multiple shapes. The shapes can be configured at runtime using Instruction Set Architecture (ISA) instruction or by hardware memory mapped input/output (MMIO) register programming. The hardware resources may be shared across the configurations. The upside of configurable execution units may be hardware sharing and better utilization than a single dedicated execution unit. However, the configurable execution units may consume more energy and area for the flexibility the architecture offers.

In particular embodiments, a processor in the computing system 220 may have any combination of dedicated and configurable execution units. The processor may operate these execution units in a parallel or mutually exclusive fashion, along with memory hierarchy and processor front end changes to feed these execution units. The execution units may communicate with each other by dedicated point-points interfaces, the processor register, the memory hierarchy of the processor subsystem or through an external memory.

### Algorithms for Mapping Hardware Resources With Calculations

A computational graph 203 may be used for representing a series of computations 210. In particular embodiments, the series of computations 210 may be machine-learning (ML) computations. A computational graph 203 may comprise a plurality of nodes and one or more directional edges. A node may represent a calculation to be performed on input data of the node. A directional edge from a first node to a second node may indicate that output of a first calculation represented by the first node is fed to a second calculation represented by the second node as input. In particular embodiments, a series of computations 210 represented by a computational graph 203 may be executed on a computing system 220 comprising a plurality of Execution Units (EUs).

In particular embodiments, a compiler 200 may map the calculation represented by each node of the computational graph 203 to a respective EU among the plurality of EUs to optimize a cost associated with the series of computations 210 before the series of computations 210 represented by the computational graph 203 is executed on the computing system 220. In particular embodiments, the computing system 220 may optimize the cost by mapping the nodes with respective EUs at runtime.

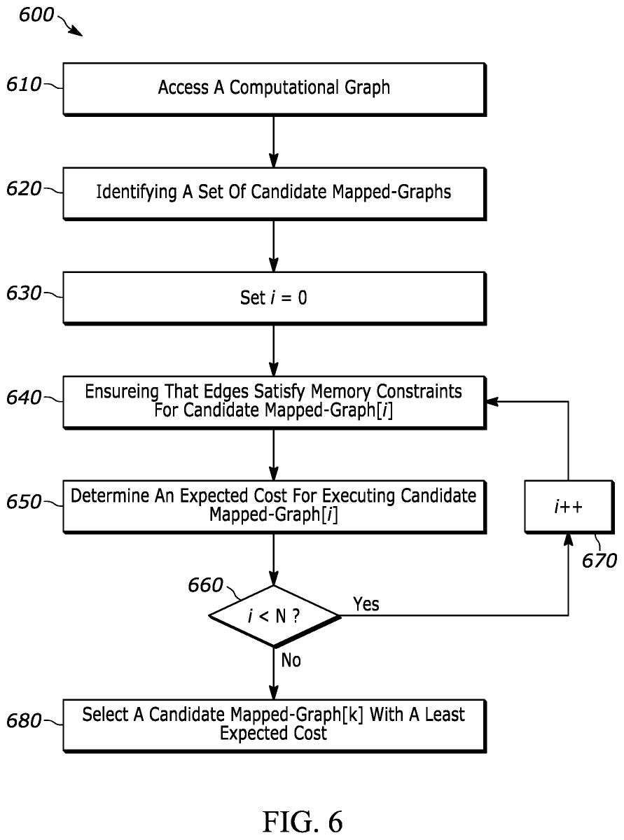

FIG. 6 illustrates an example method 600 for mapping each calculation represented by each node of a computational graph to a respective EU among a plurality of EUs of a computing system to optimize cost associated with the computations. The method may begin at step 610, where a system may access a computational graph representing computations to be executed on a computing system comprising a plurality of EUs. At step 620, the system may identify a set of candidate mapped-graphs for the computational graph. Each node in a candidate mapped-graph may be mapped to an EU capable of calculating the node. The set of candidate mapped-graphs may comprise N candidate mapped-graphs. At step 630, the system may initialize a counter i with zero. At step 640, the system may ensure that each edge from a first node to a second node in i+1^{st} candidate mapped-graph in the set, denoted by candidate mapped-graph[i], that the edge satisfies memory constraints. At step 650, the system may determine an expected cost for executing the candidate mapped-graph[i] using mapped-EUs in the candidate mapped-graph[i] for calculating respective nodes. At step 660, the system may determine whether i, a current counter value, is less than N, the number of candidate mapped-graphs in the set. The system may proceed to step 670, where the system may increment i by one and move back to step 640 when the answer of step 660 is ‘yes.’ If the answer of step 660 is ‘no,’ the system proceed to step 680 where the system may select a candidate mapped-graph with a least expected cost from the set of candidate mapped-graphs. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for mapping each calculation represented by each node of a computational graph to a respective EU among a plurality of EUs of a computing system to optimize cost associated with the computations including the particular steps of the method of FIG. 6, this disclosure contemplates any suitable method for mapping each calculation represented by each node of a computational graph to a respective EU among a plurality of EUs of a computing system to optimize cost associated with the computations including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

In particular embodiments, at step 610, a system may access the computational graph 203 representing computations 210 to be executed on the computing system 220 comprising a plurality of EUs. In particular embodiments, the system may be a system running the compiler 200. In particular embodiments, the system may be the computing system 220 itself.

In particular embodiments, at step 620, the system may identify a set of candidate mapped-graphs for the computational graph. In a candidate mapped-graph, each node may be mapped to an EU capable of calculating the node. To identify the set of candidate graphs, the system may identify, for each node in the computational graph 203, one or more EUs among the plurality of EUs that are capable of performing the calculation represented by the node. For a configurable EU, the system may identify every configuration of the configurable EU that is capable of performing the calculation represented by the node. Then, the system may identify the set of candidate mapped-graphs based on the identified one or more EUs for each node in the computational graph. Each candidate graph in the set may have a unique combination of node and EU mappings.

In particular embodiments, the system may use a brute force algorithm to identify the set of candidate mapped-graphs for the computational graph. The brute force algorithm may identify all the possible combinations of mappings between the nodes and their capable EUs. In particular embodiments, the system may use a heuristic algorithm that decreases a number of the candidate mapped-graphs in the set to identify the set of candidate mapped-graphs for the computational graph.

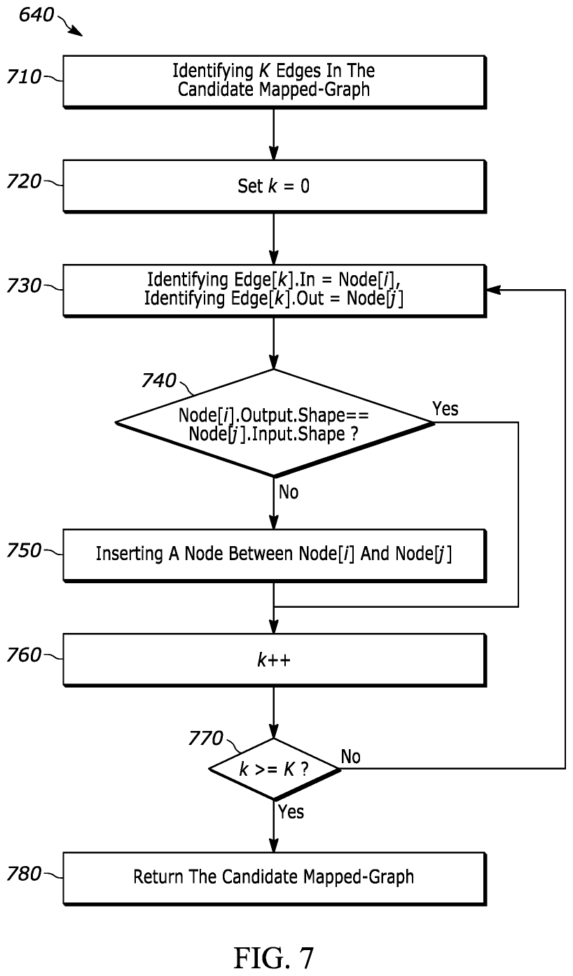

In particular embodiments, at step 640, the system may ensure that each edge from a first node to a second node in candidate mapped-graph[i] satisfies memory constraints. FIG. 7 illustrates an example procedure for ensuring that each edge from a first node to a second node in a candidate mapped-graph satisfies memory constraints. At step 710, the system may identify all of K edges in the candidate mapped-graph. At step 720, the system may initialize a counter k with zero. At step 730, the system identifying a first node, node[i], as an input node of edge[k] and a second node, node[j], as an output node of edge[k] when edge[k] is a directional edge from node[i] to node[j]. At step 740, the system may determine whether a first shape of output data from node[i] is identical to a second shape of input data to node[j]. If the answer of the determination at step 740 is ‘yes,’ the system may proceed to step 760. If the answer of the determination at step 740 is ‘no,’ the system may proceed to step 750, in which the system may insert a node between node[i] and node[j]. The inserted node may be for converting the first shape of the output data from node[i] to the second shape. Inserting the node to the candidate mapped-graph between node[i] and node[j] may also comprise mapping the node to an EU capable of converting the first shape to the second shape. Converting the first shape to the second shape may comprise a memory transpose, adding paddings, or any suitable operation for a data shape conversion. After inserting a node to the candidate mapped-graph between node[i] and node[j], the system may proceed to step 760, where the system increment the counter k by one. At step 770, the system may determine whether the counter k reaches K, the original number of edges in the candidate mapped-graph. If the result of the determination is ‘yes,’ the system may proceed to step 780 where the system returns the updated candidate mapped-graph to the method illustrated in FIG. 6. If the result of the determination at step 770 is ‘no,’ the system may move back to step 730.

In particular embodiments, at step 650, the system may determine an expected cost for executing candidate mapped-graph[i] using mapped-EUs in the candidate mapped-graph[i] for calculating respective nodes. The expected cost may be measured by latency, energy consumption, compute utilization, or any suitable measurement. The system, at step 680, may select a candidate mapped-graph with a least expected cost from the set of candidate mapped-graphs. In particular embodiments, the compiler 200 at the system may construct instructions 205 for executing the series of computations 210 based on the selected candidate mapped-graph. The computing system 220 may execute the series of computations based on the instructions 205.

### Systems and Methods

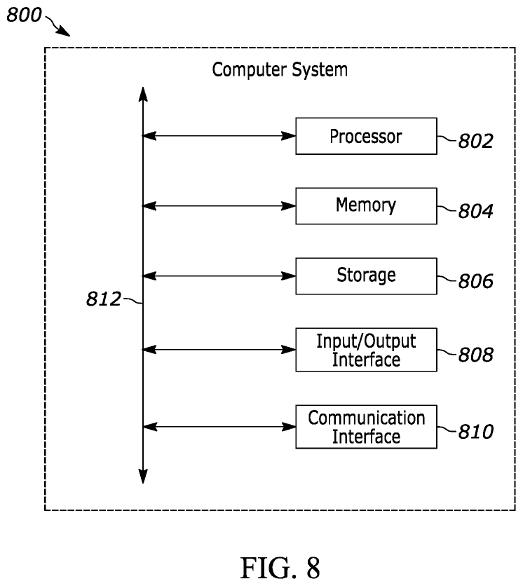

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
accessing a computational graph representing computations to be executed on a computing system comprising a plurality of Execution Units (EUs);
identifying a set of candidate mapped-graphs for the computational graph, wherein each node in a candidate mapped-graph is mapped to an EU capable of calculating the node;
ensuring, for each edge from a first node to a second node in each candidate mapped-graph, that the edge satisfies memory constraints, wherein the ensuring comprises:
determining that a first shape of an output from the first node mismatches a second shape of an input to the second node; and
inserting, in response to the determination, a third node for converting the first shape to the second shape between the first node and the second node in the candidate mapped-graph;
determining, for each candidate mapped-graph, an expected cost for executing the candidate mapped-graph using mapped-EUs for calculating respective nodes; and
selecting a candidate mapped-graph with a least expected cost from the set of candidate mapped-graphs.

2. The method of claim 1, wherein the computational graph comprises a plurality of nodes and one or more directional edges, wherein a node represents a calculation to be performed on input data, and wherein a directional edge from the first node to the second node indicates that output of a first calculation represented by the first node is fed to a second calculation represented by the second node as input.

3. The method of claim 1, wherein an EU comprises one or more computing elements and one or more memory elements, wherein the one or more memory elements store input data fed to the one or more computing elements or output data generated by the one or more computing elements.

4. The method of claim 3, wherein the EU is a tensor execution unit, a vector execution unit, an accelerator, or a scalar execution unit.

5. The method of claim 3, wherein the EU is a dedicated EU or a configurable EU, wherein a dedicated EU has a microarchitecture tuned for processing an input data of particular type and shape, and wherein a configurable EU is designed to support multiple data shapes, which can be configured at runtime.

6. The method of claim 5, wherein identifying the set of candidate graphs comprises:
identifying, for each node in the computational graph, one or more EUs capable of performing a calculation represented by the node among the plurality of EUs; and
identifying the set of candidate mapped-graphs based on the identified one or more EUs for each node in the computational graph, wherein each candidate graph in the set has a unique combination of node and EU mappings.

7. The method of claim 6, wherein identifying the one or more EUs capable of performing the calculation represented by the node comprises identifying every configuration of a configurable EU that is capable of calculating the node.

8. The method of claim 1, wherein the expected cost is measured by latency, energy consumption, or compute utilization.

9. The method of claim 1, wherein inserting the third node to the candidate mapped-graph comprises mapping the third node to an EU capable of converting the first shape to the second shape.

10. The method of claim 9, wherein converting the first shape to the second shape comprises a memory transpose or adding paddings.

11. The method of claim 1, wherein the method is performed by a compiler before computations represented by the computational graph are executed on the computing system.

12. The method of claim 1, wherein the method is performed by the computing system at runtime.

13. The method of claim 1, wherein identifying the set of candidate mapped-graphs for the computational graph is done by a brute force algorithm that identifies all possible combinations of mappings between the nodes and their capable EUs.

14. The method of claim 1, wherein identifying the set of candidate mapped-graphs for the computational graph is done by a heuristic algorithm that decreases a number of the candidate mapped-graphs in the set.

15. The method of claim 1, wherein the computing system comprises a processor that comprises the plurality of EUs.

16. The method of claim 1, wherein the computing system comprises the plurality of EUs distributed from a processor.

17. A system comprising:
one or more processors; and
one or more computer-readable non-transitory storage media coupled to one or more of the processors and comprising instructions operable when executed by one or more of the processors to cause the system to:
access a computational graph representing computations to be executed on a computing system comprising a plurality of Execution Units (EUs);
identify a set of candidate mapped-graphs for the computational graph, wherein each node in a candidate mapped-graph is mapped to an EU capable of calculating the node;
ensure, for each edge from a first node to a second node in each candidate mapped-graph, that the edge satisfies memory constraints, wherein the ensuring comprises:
determining that a first shape of an output from the first node mismatches a second shape of an input to the second node; and
inserting, in response to the determination, a third node for converting the first shape to the second shape between the first node and the second node in the candidate mapped-graph;
determine, for each candidate mapped-graph, an expected cost for executing the candidate mapped-graph using mapped-EUs for calculating respective nodes; and
select a candidate mapped-graph with a least expected cost from the set of candidate mapped-graphs.

18. The system of claim 17, wherein the computational graph comprises a plurality of nodes and one or more directional edges, wherein a node represents a calculation to be performed on input data, and wherein a directional edge from the first node to the second node indicates that output of a first calculation represented by the first node is fed to a second calculation represented by the second node as input.

19. The system of claim 17, wherein an EU comprises one or more computing elements and one or more memory elements, wherein the one or more memory elements store input data fed to the one or more computing elements or output data generated by the one or more computing elements.

20. One or more computer-readable non-transitory storage media embodying software that is operable when executed to:
access a computational graph representing computations to be executed on a computing system comprising a plurality of Execution Units (EUs);
identify a set of candidate mapped-graphs for the computational graph, wherein each node in a candidate mapped-graph is mapped to an EU capable of calculating the node;
ensure, for each edge from a first node to a second node in each candidate mapped-graph, that the edge satisfies memory constraints, wherein the ensuring comprises:
determining that a first shape of an output from the first node mismatches a second shape of an input to the second node; and
inserting, in response to the determination, a third node for converting the first shape to the second shape between the first node and the second node in the candidate mapped-graph;
determine, for each candidate mapped-graph, an expected cost for executing the candidate mapped-graph using mapped-EUs for calculating respective nodes; and
select a candidate mapped-graph with a least expected cost from the set of candidate mapped-graphs.
